(19) United States
(12) Patent Application Publication
(10) Pub. No.: US 2025/0218418 A1
(43) Pub. Date: Jul. 3, 2025

(54) AUDIO DETECTION METHOD AND APPARATUS, STORAGE MEDIUM AND ELECTRONIC DEVICE

(71) Applicant: Beijing Zitiao Network Technology Co., Ltd., Beijing (CN)

(72) Inventor: Qiaomu WANG, Beijing (CN)

(21) Appl. No.: 18/844,887

(22) PCT Filed: Feb. 28, 2023
(86) PCT No.: PCT/CN2023/078752

§ 371 Date: Sep. 6, 2024

(30) Foreign Application Priority Data
Mar. 8, 2022 (CN) 202210220184.7

(51) Int. Cl. G10H 1/00; G06N 20/00

(52) U.S. Cl. CPC G10H 1/0008; G06N 20/00; G10H 1/0041; G10H 2210/031; G10H 2240/075; G10H 2240/141

(57) ABSTRACT

An audio detection method and apparatus, a storage medium, and an electronic device. The audio detection method includes: acquiring an audio segment in detected audio, and recognizing a music event in the audio segment; determining metadata information matched with the music event, and determining statistical data in the detected audio on the basis of the metadata information.

The present application claims priority to Chinese Patent Application No. 202210220184.7 filed with the CNIPA on Mar. 8, 2022, which is incorporated herein by reference in its entirety.

### TECHNICAL FIELD

The present disclosure relates to the technical field of audio processing, for example, to an audio detection method and apparatus, a storage medium, and an electronic device.

### BACKGROUND

With the popularization of Internet technology as well as the rapid popularity of audios and videos, users can play audios and videos, such as live programs, songs, audio novels, etc., through electronic devices such as cellular phones, computers, and the like.

There is at least the following technical problem in the related art: the audio detection method cannot acquire music-related statistical data (e.g., music duration, music playback start-end time, etc.) in an audio to be detected.

### SUMMARY

The present disclosure provides an audio detection method and apparatus, a storage medium and an electronic device to achieve accurate acquisition of statistical data in an audio to be detected.

In a first aspect, the present disclosure provides an audio detection method, including:
acquiring an audio segment in a detected audio, and recognizing a music event in the audio segment; and
determining metadata information matched with the music event, and determining statistical data in the detected audio based on the metadata information.

In a second aspect, the present disclosure further provides an audio detection apparatus, including:
a music event recognition module, configured to acquire an audio segment in a detected audio and recognize a music event in the audio segment; and
a statistical data determination module, configured to determine metadata information matched with the music event, and determine statistical data in the detected audio based on the metadata information.

In a third aspect, the present disclosure further provides an electronic device, including:
one or more processors; and
a storage device configured to store one or more programs;
the one or more programs, when executed by the one or more processors, are configured to cause the one or more processors to implement the audio detection method described above.

In a fourth aspect, the present disclosure further provides a storage medium comprising computer-executable instructions, wherein the computer-executable instructions, when executed by a computer processor, are configured to implement the audio detection method described above.

In a fifth aspect, the present disclosure further provides a computer program product comprising a computer program carried on a non-transitory computer readable medium, wherein the computer program comprises program codes configured to implement the audio detection method described above.

### BRIEF DESCRIPTION OF DRAWINGS

FIG. 1 is a flowchart of an audio detection method according to an embodiment of the present disclosure;

FIG. 2 is a flowchart of another audio detection method according to an embodiment of the present disclosure;

FIG. 3 is a flowchart of another audio detection method according to an embodiment of the present disclosure;

FIG. 4 is a flowchart of another audio detection method according to an embodiment of the present disclosure;

FIG. 5 is a flowchart of another audio detection method according to an embodiment of the present disclosure;

FIG. 6 is a structural diagram of an audio detection apparatus according to an embodiment of the present disclosure; and

FIG. 7 is a structural diagram of an electronic device according to an embodiment of the present disclosure.

### DETAILED DESCRIPTION

Embodiments of the present disclosure will be described below with reference to the accompanying drawings. While some embodiments of the present disclosure are shown in the drawings, the present disclosure may be embodied in many forms, with these embodiments being provided to provide an understanding of the present disclosure. The figures and examples of the present disclosure are for illustrative purposes only.

The multiple steps recited in the method implementation of the present disclosure may be performed in a different order, and/or in parallel. Further, the method implementation may include additional steps and/or omit performing illustrated steps. The scope of the present disclosure is not limited in this regard.

As used herein, the term “comprise/include” and variations thereof are opened inclusion, that is, “comprising/including, but not limited to”. The term “based on” is “based at least in part on”. The term “one embodiment” means “at least one embodiment”; the term “another embodiment” means “at least one additional embodiment”; the term “some embodiments” means “at least some embodiments”. Relevant definitions for other terms will be given in the description below.

The concepts of “first”, “second”, and the like mentioned in the present disclosure are only used to distinguish different devices, modules, or units, and are not used to limit the order or interdependence of functions performed by these devices, modules, or units.

Modifiers referred to in this disclosure, such as “a/an” and “a plurality of”, are intended to be illustrative rather than limitative, and should be interpreted as “one or more” unless the context dictates otherwise, which should be appreciated by those skilled in the art.

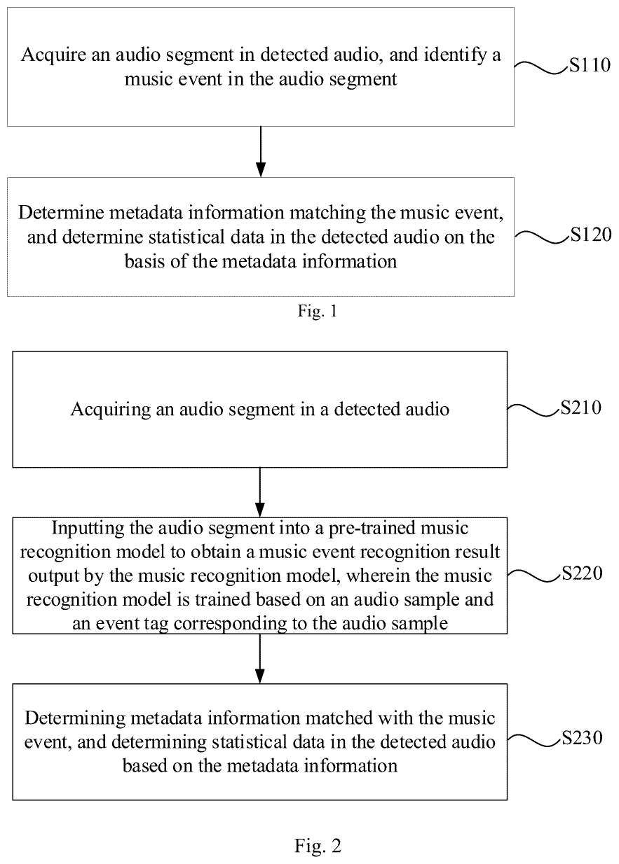

FIG. 1 is a flowchart of an audio detection method provided by an embodiment of the present disclosure. The embodiment of the present disclosure is adapted to the case where statistical data of music events is automatically acquired in an audio. The method may be performed by an audio detection apparatus provided by an embodiment of the present disclosure, the audio detection apparatus may be implemented in the form of software and/or hardware by an electronic device, and the electronic device may be a mobile terminal or a personal computer (PC) terminal, or the like. As shown in FIG. 1, the method of the present embodiment includes:
S110, acquiring an audio segment in a detected audio, and recognizing a music event in the audio segment.
S120, determining metadata information matched with the music event, and determining statistical data in the detected audio based on the metadata information.

In an embodiment of the present disclosure, the electronic device may be any electronic device having an audio/video playing function and/or an audio/video processing function, and may include, but be not limited to, a smartphone, a wearable device, a computer, a server, and the like. The electronic device described above can acquire a detected audio in a variety of ways. For example, the detected audio may be captured in real-time by an audio capture device, or may be retrieved from a preset storage location or other devices, and the method of acquiring the detected audio is not limited in the embodiments of the present disclosure.

A detected audio refers to an audio for which statistical data detection is desired, and may include, but be not limited to, an audio in a live video, an audio in a video, an audio in a broadcast, and the like, which is limited in the present disclosure. Accordingly, in some embodiments, acquiring the detected audio may be extracting audio data from a video (e.g., real-time live video or offline video) as the detected audio.

In order to improve recognition accuracy and recognition efficiency of the audio, the detected audio is divided into a plurality of audio segments, and recognition processing is performed on each of the audio segments. In the case where the detected audio is real-time data, the audio collected in real time is divided into audio segments sequentially, and the recognition processing is performed on the resulting audio segments in real time. In the case where the detected audio is offline data, the recognition processing may be performed on each audio segment in turn according to the timing of dividing the audio segments. In some embodiments, for offline audio data, parallel data may be performed on the resulting multiple audio segments to improve processing efficiency.

In this embodiment, an audio segment may be audio data having a preset duration, and the audio segment may contain one or more of a music event, an ambient sound event, a voice event, a noise event, and the like. Here, the duration of the audio segment may be set in advance, e.g., determined according to recognition accuracy, without limited in the present disclosure. For example, the duration of the audio segment may be 20 s. A music event refers to a sound event that may be characterized by one or more of the elements such as tempo (e.g., beat and pronunciation), tone (e.g., melody and harmony) and strength (e.g., volume of a sound or a musical note), and may include, but be not limited to, a background music event, an unaccompanied singing event, and the like.

In order to recognize a music event in an audio segment, a feature analysis of the audio segment is required to determine whether the audio segment contains a music event. In some embodiments, at least one sound feature may be extracted by any feature extraction method (e.g., Mel-cepstral coefficient extraction method, linear prediction coefficient extraction method, etc.), the extracted sound feature may be compared with music features in a music database which may be a database containing a plurality of types of music features, and whether the audio segment contains a music event may be determined based on the comparison result. In some embodiments, the audio segment may be recognized through a music recognition model, and whether the audio segment contains a music event may be determined according to the recognition result. In the music recognition model, music, chat voice, noise and the like may be taken as training samples, in which audio data containing music is used as a positive sample, and audio data that doesn't contain music, e.g., chat voice, noise and the like, is used as a negative sample. The music recognition model is trained based on the above sample data, and a model having a music event recognition function is obtained when a training ending condition is satisfied. The present embodiment does not limit the method of recognizing a music event.

On the basis of the above embodiment, metadata information matched with the music event is determined for audio segments where a music event exists, respectively, to obtain statistical data of the detected audio; matching of metadata information is not necessary for the audio segments which do not include a music event, so as to avoid wasting of computing resources due to invalid processing. The metadata information is descriptive information of music metadata including music features in the music event. In some embodiments, the metadata information may be a tag formed by a plurality of descriptive information of music metadata. The descriptive information of music metadata may include, but is not limited to, spectral information of music, name of music, type of music, singer, composer, and the like, without limited in the present disclosure. By way of example, the metadata information may be in the form of name of music-singer/player. The music metadata is characterized by the metadata information, and the metadata information has uniqueness, so that the music metadata can be uniquely represented; the metadata information is used as a statistical dimension, so that the reliability of statistic of music events in the audio can be improved; then the statistic of music events is performed for a plurality of audio segments through the metadata information, so that the accuracy of the corresponding statistical data of the music events can be improved.

In some embodiments, metadata information matched with the music event may be determined by extracting a music feature in the music event, matching the music feature with music features corresponding to a plurality of pieces of music metadata, and determining the metadata information of the music metadata matched successfully as the metadata information matched with the music event. In some embodiments, the music features include, but are not limited to, feature information of tone, beat, lyrics, etc., and accordingly, an extraction of the above-mentioned feature information is performed on the music event, the extracted feature information is matched in a preset metadata library, and the metadata information matched with the music event is obtained, wherein the preset metadata library may contain a plurality of pieces of metadata information and feature information corresponding to the metadata information. In some embodiments, the music feature may be an audio fingerprint feature. Accordingly, an audio fingerprint feature of the audio segment is extracted, and metadata information matched with the music event is determined based on the audio fingerprint feature being matched in a fingerprint feature library, wherein the fingerprint feature library includes music metadata and corresponding fingerprint features. For the one-to-one correspondence between the audio fingerprint features and the audio segments for which the audio fingerprint features are determined, in this embodiment, the music metadata may correspond to a plurality of fingerprint features, the music metadata may be divided into a plurality of pieces of music sub-data, the plurality of pieces of music sub-data may be partly overlapped, and the fingerprint feature corresponding to each piece of music sub-data may be determined separately. Accordingly, the matching of the audio fingerprint feature of the audio segment with the fingerprint feature of the music metadata may be performed by matching the audio fingerprint feature of the audio segment with the fingerprint features of the plurality of pieces of music sub-data in the music metadata, respectively; and if the audio fingerprint feature of the audio segment is successfully matched with the fingerprint feature of any of the music sub-data, the metadata information of the music metadata to which the music sub-data belongs is determined as the metadata information corresponding to the music event in the audio segment.

The statistical data is a result of statistic of music events in a plurality of audio segments, i.e., music statistical data. Here, the statistical data may include, but is not limited to, a plurality of music playback durations, a music playback start time and a music playback end time, and the number of receiving users (e.g., listening users of the audio or viewing users of a video to which the audio belongs) during the plurality of music playbacks, in the detected audio; and the type of statistical data in the statistical data may be determined according to service requirements, without limited in the present disclosure.

In some embodiments, the statistic of audio durations corresponding to all music events corresponding to each piece of metadata information in the detected audio may be performed based on the metadata information corresponding to each music event; it is also possible to determine consecutive music events to which the metadata information corresponds, and the number of consecutive music events to which each piece of metadata information in the detected audio corresponds, according to the metadata information to which the music event corresponds and the timestamp of the music event, so as to obtain the application situation of the music in the detected audio; it is also possible to perform a statistic of an audio interval to which each piece of metadata information in the detected audio corresponds, and the number of receiving users for each audio interval, so as to evaluate the viewer-attracting capability and the like of the music to which each piece of metadata information corresponds.

On the basis of the above embodiment, after acquiring the statistical data, it may further include: acquiring music metadata corresponding to the music event according to the metadata information corresponding to each music event, and restoring the music event in the audio segment according to the music metadata corresponding to the music event to obtain a restored music event; in this way, it can avoid any disturbance of the noise included in the detected audio which may result in an unclear music event. The music event in the audio segment is restored according to the music metadata corresponding to the music event, which may be realized by intercepting music sub-data in the music metadata corresponding to the music event, and replacing the audio data of the music event by the music sub-data. Alternatively, after acquiring the statistical data, it may further include: performing operations such as trimming and splicing on the audio segment according to the metadata information corresponding to the music event in each audio segment to obtain one or more new audio segments; for example, performing trimming and splicing on the audio data in the detected audio corresponding to the same metadata information.

In the audio detection method provided by the embodiments of the present disclosure, preliminary recognition of music events in a plurality of audio segments is achieved by acquiring audio segments in the detected audio and recognizing music events in the audio segments; matching acquisition of reference data is achieved by determining metadata information matched with the music event, which provides a reference basis for acquiring statistical data; recognition and statistic of music dimensions on the audio are achieved by acquiring statistical data in the detected audio through a statistic performed on music events in a plurality of audio segments according to the metadata information obtained from matching, which facilitates subsequent analysis of the detected audio based on the statistical data and enables accurate acquisition of statistical data of music events.

Referring to FIG. 2, which is a flowchart of another audio detection method provided by an embodiment of the present disclosure. The method of the present embodiment may be combined with various aspects of the audio detection method provided in the above embodiment. In the audio detection method provided by this embodiment, the recognizing the music event in the audio segment includes: inputting the audio segment into a pre-trained music recognition model to obtain a music event recognition result output by the music recognition model, wherein the music recognition model is trained based on an audio sample and an event tag corresponding to the audio sample.

As shown in FIG. 2, the method of the present embodiment includes:
S210, acquiring an audio segment in a detected audio.
S220, inputting the audio segment into a pre-trained music recognition model to obtain a music event recognition result output by the music recognition model, wherein the music recognition model is trained based on an audio sample and an event tag corresponding to the audio sample.
S230, determining metadata information matched with the music event, and determining statistical data in the detected audio based on the metadata information.

In this embodiment, the music recognition model has the capability of recognizing music events in the audio data; and for an input audio segment, it can recognize whether the audio segment includes a music event. Accordingly, the training process of the music recognition model may include: acquiring an audio sample and an event tag corresponding to the audio sample. The audio sample may include a plurality of different sound events, such as music event, laughter event, chat event, noise event, and the like; accordingly, the event tag corresponding to the audio sample may be an event identifier, such as music identifier, laughter identifier, noise identifier, and the like. An audio sample including a music event is taken as a positive sample, and an audio sample including a laughter, a chat, a noise, etc. is taken as a negative sample; accordingly, the event tags corresponding to the positive and negative samples may be positive and negative, respectively. An initial training model is trained based on the audio samples corresponding to the positive and negative samples and the event tags corresponding to the audio samples, to obtain a music recognition model. The initial training model may include, but is not limited to, a long short-term memory network model, a support vector machine model, and the like, without limited in the present disclosure. After the training of the music recognition model is completed, the audio segments may be input into the pre-trained music recognition model, the sound events in the audio segments are classified or recognized, and a music event recognition result may be quickly output by the music recognition model. The pre-trained music recognition model is available in online applications of an audio detection apparatus, through which music event recognition results can be quickly obtained without complex calculations, thereby increasing the speed of audio detection.

On the basis of the above embodiment, the music recognition model may also output a start-end timestamp of the recognized music event in the audio segment. Accordingly, the training sample of the music recognition model further includes a start-end timestamp corresponding to the tag of the music event in the audio sample, and the music recognition model trained through the training sample can recognize whether a music event is included in the input audio segment and the start-end timestamp of the music event.

After recognizing the music event in the audio segment, the method further includes: determining whether a duration of the music event in the audio segment is greater than a first preset duration, and cancelling a tag for the music event in the audio segment if the duration of the music event in the audio segment is not greater than the first preset duration. The duration of the music event may be determined based on the start-end timestamp of the music event.

When a music event is included in the music event recognition result, it indicates that the audio segment in the detected audio may include an event such as playing music or singing. However, it may also be caused by a distracting sound, such as a prompt tone for text message or a phone ring with short duration, or the like, and the distracting sound may also include music. Such situation indicates that the music event in the audio segment is not a true music event and that a tag for the music event needs to be cancelled to avoid a false judgement of music event.

The duration of the music event in the audio segment is determined; if the duration of the music event in the audio segment is greater than a first preset duration, it indicates that the music event meets the criteria for music, and the music event tag for the audio segment remains unchanged; if the duration of the music event in the audio segment is less than or equal to the first preset duration, it indicates that the music event does not meet the criteria for music, and the music event tag for the audio segment is canceled. The first preset duration may be set according to historical experience, for example, the first preset duration may be 6 s.

In the audio detection method provided by the embodiment of the present disclosure, sound events in the audio segments are classified or recognized by inputting the audio segments into a pre-trained music recognition model to obtain a music event recognition result. The music events of which the duration is less than or equal to the first preset duration are removed, thereby reducing the interference of misrecognizing music events, and reducing the increase of statistical workload resulted by short-time music events.

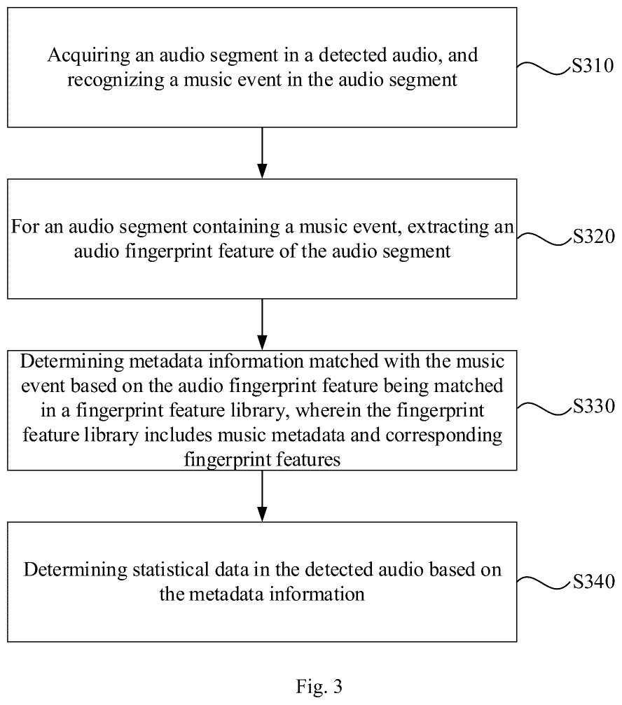

Referring to FIG. 3, which is a flowchart of another audio detection method according to an embodiment of the present disclosure. The method according to the present embodiment may be combined with various aspects of the audio detection method according to the above embodiments. In the audio detection method provided by this embodiment, determining metadata information matched with the music event includes: for an audio segment containing a music event, extracting an audio fingerprint feature of the audio segment; and determining metadata information matched with the music event based on the audio fingerprint feature being matched in a fingerprint feature library, wherein the fingerprint feature library includes music metadata and corresponding fingerprint features. As shown in FIG. 3, the method of the present embodiment includes:
S310, acquiring an audio segment in a detected audio, and recognizing a music event in the audio segment.
S320, for an audio segment containing a music event, extracting an audio fingerprint feature of the audio segment.
S330, determining metadata information matched with the music event based on the audio fingerprint feature being matched in a fingerprint feature library, wherein the fingerprint feature library includes music metadata and corresponding fingerprint features.
S340, determining statistical data in the detected audio based on the metadata information.

In this embodiment, an audio fingerprint feature refers to a digital feature of a music event, i.e., a music fingerprint feature with uniqueness. The extraction of audio fingerprint features may be performed on the audio segments by audio fingerprinting techniques including, but not limited to, the Philips algorithm or the Shazam algorithm, among others.

The fingerprint feature library refers to a database containing music metadata and fingerprint features, which may be pre-stored with a plurality of pieces of music metadata and corresponding fingerprint features of the music metadata. Matching the fingerprint feature corresponding to the music metadata with the audio fingerprint feature, and if the matching is successful, the metadata information matched with the music event is obtained. The fingerprint features may include, but are not limited to, frequency parameters and time parameters corresponding to the frequency spectrum of the music metadata.

On the basis of the above embodiment, the extracting the audio fingerprint feature of the audio segment includes: intercepting the audio segment according to a start-end timestamp of the music event in the audio segment to obtain an intercepted audio segment, and extracting the audio fingerprint feature of the intercepted audio segment. In some embodiments, a start-end timestamp of the music event is included in the recognition result of the music event. Acquiring a start timestamp and an end timestamp of the music event in the audio segment, extracting the audio data corresponding to the music event in the audio segment by intercepting the audio segment according to the start timestamp and the end timestamp of the music event, and determining the audio fingerprint feature of only the audio data corresponding to the intercepted music event by eliminating a portion of the audio data of the non-music event, thereby avoiding interference to the audio fingerprint feature resulted by the portion of the audio data of the non-music event while reducing the amount of audio data for determining the audio fingerprint feature, which facilitates rapid extraction of the audio fingerprint feature.

On the basis of the above embodiment, the extracting the audio fingerprint feature of the audio segment includes: extracting audio data, in the audio segment, of an audio track where the music event is located, and extracting the audio fingerprint feature based on the audio data of the audio track where the music event is located. In some embodiments, the detected audio may include a plurality of audio tracks, i.e., each audio segment may include a plurality of audio tracks. Illustratively, the detected audio may include a background capturing audio track and a voice capturing audio track; in any one of the audio segments, the audio data in the background capturing audio track may be background music and the audio data in the voice capturing audio track may be conversational voice data of a host; illustratively, the audio data in the background capturing audio track may be noise, and the audio data in the voice capturing audio track may be singing voice of the host. Music events may be included simultaneously in different audio tracks, or, music events may be included independently in one or more of the audio tracks. By extracting audio data from audio tracks where music events are located and removing music data from audio tracks where non-music events are located, interference from non-music events is reduced and the accuracy of subsequent extraction of audio fingerprint feature is improved.

The audio detection method provided by the embodiment of the present disclosure can achieve fast processing speed and save the time of audio detection by extracting, for an audio segment containing a music event, an audio fingerprint feature of the audio segment, matching the extracted audio fingerprint feature in a fingerprint feature library, determining metadata information matched with the music event, and acquiring metadata information corresponding to the music event through the matching in the fingerprint feature library.

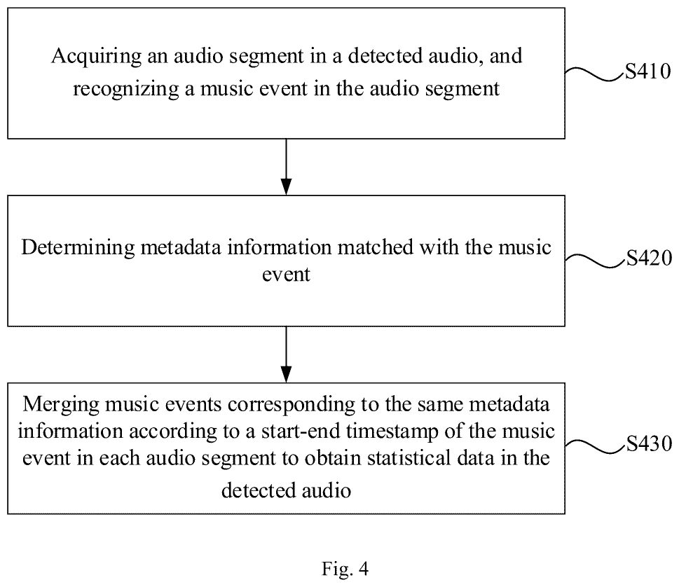

Referring to FIG. 4, which is a flowchart of another audio detection method according to an embodiment of the present disclosure. The method of the present embodiment may be combined with various aspects of the audio detection method according to the above embodiments. In the audio detection method provided by this embodiment, the determining statistical data in the detected audio based on the metadata information includes: merging music events corresponding to the same metadata information according to the start-end timestamp of the music event in each audio segment to obtain statistical data in the detected audio.

As shown in FIG. 4, the method of the present embodiment includes:
S410, acquiring an audio segment in a detected audio, and recognizing a music event in the audio segment.
S420, determining metadata information matched with the music event.
S430, merging music events corresponding to the same metadata information according to a start-end timestamp of the music event in each audio segment to obtain statistical data in the detected audio.

The start-end timestamp of a music event refers to a start timestamp and an end timestamp of the music event. If a plurality of music events corresponds to the same metadata information, it indicates that the plurality of music events are part of the same piece of music or song. The music events correspond to the same metadata information may be merged, and statistical data in the detected audio may be determined based on the merged music events, so that recognition errors caused by the division of audio segments for the detected audio data may be avoided, and accuracy of the statistical data may be improved.

On the basis of the above embodiment, the merging music events corresponding to the same metadata information according to the start-end timestamp of the music event in each audio segment to obtain statistical data in the detected audio, includes: for adjacent music events, if the adjacent music events correspond to the same metadata information and an interval duration between the adjacent music events is less than a second preset duration, merging the adjacent music events; if the adjacent music events correspond to different metadata information, or, if the adjacent music events correspond to the same metadata information and the interval duration between the adjacent music events is greater than or equal to the second preset duration, the adjacent music events are not merged.

Adjacent music events may be music events in adjacent audio segments or adjacent music events within an audio segment, without limited in the present disclosure.

Exemplarily, for adjacent music events, if the adjacent music events correspond to the same metadata information and an interval duration between the adjacent music events is less than a second preset duration, it indicates that the adjacent music events belong to the same song, and the interval between the two music events is normal singing or playing pause, or recognition error due to division of audio segments; in this case, the adjacent music events may be merged to calibrate the recognized music events. If the adjacent music events correspond to different metadata information, it indicates that the adjacent music events do not belong to the same song; in this case, the adjacent music events are not merged, so as to make a discriminate statistic for different songs. If the adjacent music events correspond to the same metadata information, and the interval duration between the adjacent music events is greater than or equal to the second preset duration, it indicates that the adjacent music events belong to the same song but have a long pause time therebetween, for example, the same song is played twice; in this case, the adjacent music events are not merged, so as to prevent from taking the same song with a long playback interval into the same statistical data.

In the audio detection method provided by the embodiment of the present disclosure, by merging music events corresponding to the same metadata information according to the start-end timestamp of the music event in each audio segment, the audio segments containing merged music events can be obtained, so as to accurately acquire the music events in the detected audio, thereby improving the accuracy of the statistical data.

On the basis of the above embodiment, the detected audio is an audio in a live video; the method further includes: determining viewing data for a live interval to which each piece of metadata information in the statistical data corresponds.

The live video may be a live video captured in real time or may be a historical live video. An audio extraction from the live video results in a detected audio. Recognition and statistic of music events are performed on the audio extracted from the live video, so as to obtain the usage of music metadata in the live video.

The viewing data of the live interval refers to statistical viewing data of the live interval during a preset time period. The viewing data may include, but be not limited to, the total number of views, the number of independent visits, and the average viewing time. The statistical data can be taken as a matching condition for the viewing data. Matching the viewing data of the live interval in a live database according to the matching condition, which enables accurate acquisition of the viewing data. The live database can include, but be not limited to, video viewing data in real-time statistic. The statistical data of the music metadata in the live video, and the video viewing data to which the statistical data corresponds, are used for evaluating the viewer-attracting capability of the music metadata in the live video, or used for trending predictions on the music metadata.

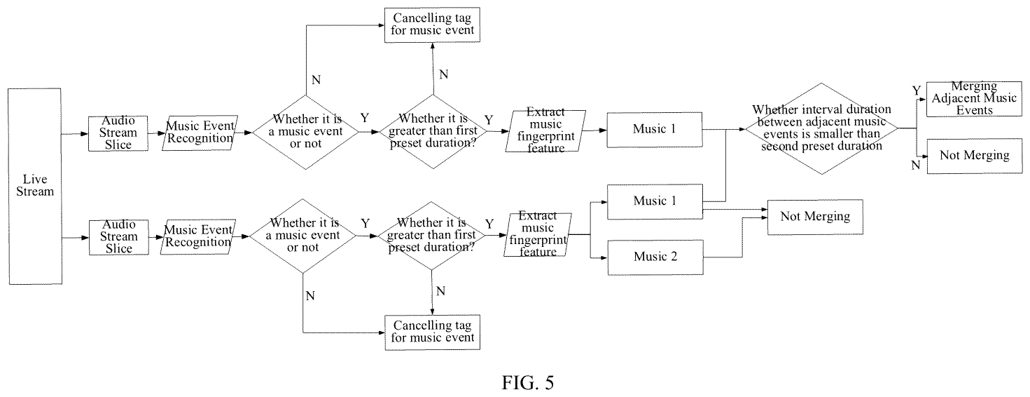

Referring to FIG. 5, which is a flowchart of another audio detection method according to an embodiment of the present disclosure. The present embodiment provides an example on the basis of the above embodiment, and explains the audio detection method in the above embodiment.

As shown in FIG. 5, the method of the present embodiment includes the following process.

Taking the live video as an example, an audio in the live stream is divided to obtain multiple audio stream slices (i.e., the audio segments described above), which can be processed in parallel.

Performing music event recognition on the audio stream slices, including: extracting short-time features and long-time features for each audio stream slice, performing dimensionality reduction on the extracted short-time features and long-time features by a dimensionality reduction algorithm to remove redundant information of the short-time features and the long-time features, so as to obtain essential features. The number of dimensions of the features with dimensionality reduction is greatly reduced and the performance is improved to some extent. The essential features are input to a support vector machine (SVM) classifier to obtain a recognition result. The short-term features include at least one of the following: perceptual linear predictive coefficients (PLPs), linear predictive cepstrum coefficients (LPCC), linear frequency cepstral coefficients (LFCCs), pitch, short-time energy (STE), sub-band energy distribution (SBED), brightness (BR), and bandwidth (BW). The long-term features include at least one of the following: spectrum flux (SF), long-term average spectrum (LTAS), and LPC entropy.

If the recognition result is a music event, continuing to determine whether the duration of the current music event is greater than the first preset duration; if the recognition result is not a music event, cancelling a tag for the music event. If the duration of the current music event is greater than the first preset duration, continuing to extract audio fingerprint features of the music event; if the duration of the current music event is not greater than the first preset duration, cancelling a tag for the music event.

Audio fingerprint features are extracted for music events by an audio fingerprinting algorithm, and the audio fingerprint features are matched in a fingerprint feature library to obtain metadata information. Adjacent music events are merged if the adjacent music events correspond to the same metadata information (i.e., the adjacent music events belong to the same song) and the interval duration between the adjacent music events is less than a second preset duration (i.e., the two belong to the same song and the interval merely is normal singing or playing pause); if the adjacent music events correspond to the same metadata information and the interval duration between the adjacent music events is no less than the second preset duration, it indicates that the adjacent music events belong to the same song but have a long pause time and are not suitable for merging, then the adjacent music events are not merged. If the adjacent music events correspond to different metadata information, i.e., the adjacent music events do not belong to the same song, the adjacent music events are not merged.

After the merging of the adjacent music events, the method further includes: acquiring statistical data of the merged music events, such as playback start time and playback end time of the music events. The statistical data can be used for music copyright billing.

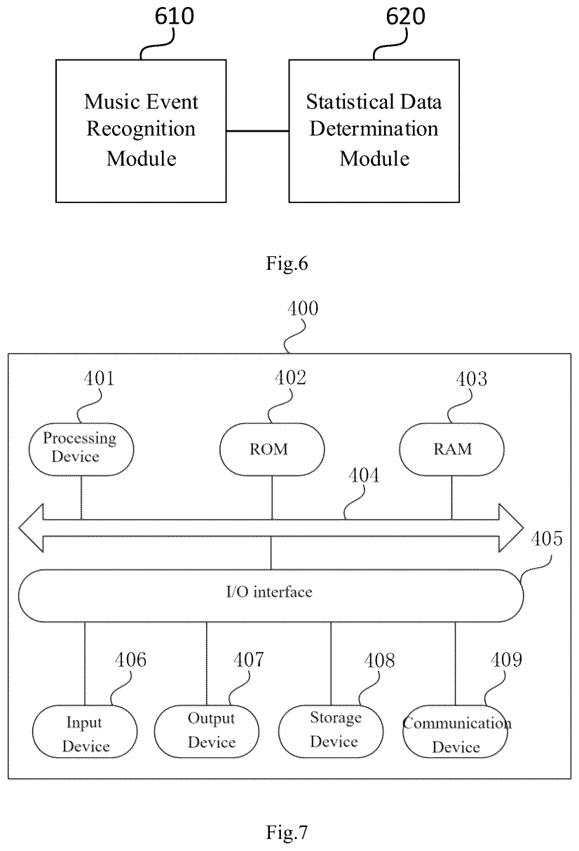

FIG. 6 is a structural diagram of an audio detection apparatus according to an embodiment of the present disclosure. As shown in FIG. 6, the apparatus includes:
a music event recognition module 610, configured to acquire an audio segment in a detected audio, and recognize a music event in the audio segment; a statistical data determination module 620, configured to determine metadata information matched with the music event and determine statistical data in the detected audio based on the metadata information.

In some implementations of the embodiment of the present disclosure, the music event recognition module 610 may be further configured to:
input the audio segment into a pre-trained music recognition model to obtain a music event recognition result output by the music recognition model, wherein the music recognition model is trained based on audio samples and event tags corresponding to the audio samples.

In some implementations of the embodiment of the present disclosure, the apparatus may be further configured to:
determine whether a duration of the music event in the audio segment is greater than a first preset duration, and cancel a tag for the music event in response to the duration of the music event in the audio segment being not greater than the first preset duration.

In some implementations of the embodiment of the present disclosure, the statistical data determining module 620 may further include:
a fingerprint feature extraction unit configured to, for an audio segment containing a music event, extract audio fingerprint features of the audio segment; and a metadata matching unit configured to determine metadata information matched with the music event based on the audio fingerprint feature being matched in a fingerprint feature library, wherein the fingerprint feature library includes music metadata and corresponding fingerprint features.

In some implementations of the embodiment of the present disclosure, the fingerprint feature extracting unit may be further configured to:
intercept the audio segment according to a start-end timestamp of the music event in the audio segment to obtain an intercepted audio segment, and extract audio fingerprint features of the intercepted audio segment; alternatively, extract, in the audio segment, audio data of an audio track where the music event is located, and extract the audio fingerprint features based on the audio data of the audio track where the music event is located.

In some implementations of the embodiment of the present disclosure, the statistical data determination module 620 may further include:
a data merging unit configured to merge music events corresponding to the same metadata information according to the start-end timestamps of the music events in each audio segment to obtain statistical data in the detected audio.

In some implementations of the embodiment of the present disclosure, the data merging unit may be further configured to:
for adjacent music events, merge the adjacent music events if the adjacent music events correspond to the same metadata information and an interval duration between the adjacent music events is less than a second preset duration; and the adjacent music events are not merged if the adjacent music events correspond to different metadata information, or, if the adjacent music events correspond to the same metadata information and the interval duration between the adjacent music events is greater than or equal to the second preset duration.

In some implementations of the embodiment of the present disclosure, the detected audio is an audio in a live video; the apparatus may be further configured to: determine viewing data for a live interval to which each piece of metadata information in the statistical data corresponds.

The audio detection apparatus provided by the embodiments of the present disclosure can perform the audio detection method provided by any of the embodiments of the present disclosure, and has corresponding functional modules and effects to perform the audio detection method.

The plurality of units and modules included in the above apparatus are divided only according to functional logic, but are not limited to the above division as long as corresponding functions can be realized. In addition, the names of the plurality of functional units are also merely for convenience of distinguishing them from each other, and are not used to limit the scope of protection of the embodiments of the present disclosure.

Reference is now made to FIG. 7, which shows a schematic structural diagram of an electronic device (e.g., a terminal device or a server in FIG. 7) 400 suitable for use in implementing embodiments of the present disclosure. The terminal device in the embodiment of the present disclosure may include, but is not limited to, a mobile terminal such as a mobile phone, a notebook computer, a digital broadcast receiver, a personal digital assistant (PDA), a tablet computer (PAD), a portable media player (PMP), a vehicle-mounted terminal (e.g., a vehicle-mounted navigation terminal), and the like, and a fixed terminal such as a digital television (TV), a desktop computer, and the like. The electronic device 400 illustrated in FIG. 7 is merely an example, and should not bring any limitation to the functionality and use of scope of the embodiments of the present disclosure.

As shown in FIG. 7, the electronic device 400 may include a processing device (e.g., a central processor, a graphics processor, etc.) 401 that may execute various appropriate actions and processes according to a program stored in a read-only memory (ROM) 402 or a program loaded into a random-access memory (RAM) 403 from a storage device 408. In the RAM 403, a variety of programs and data required for the operation of the electronic device 400 are also stored. The processing device 401, the ROM 402 and the RAM 403 are connected to each other by a bus 404. An input/output (I/O) interface 405 is also connected to the bus 404.

Generally, the following devices may be connected to the I/O interface 405: an input device 406 including, for example, a touch screen, a touch pad, a keyboard, a mouse, a camera, a microphone, an accelerometer, a gyroscope, etc.; an output device 407 including, for example, a liquid crystal display (LCD), a speaker, a vibrator, etc.; a storage device 408 including, for example, a magnetic tape, a hard disk, etc.; and a communication device 409. The communication device 409 may allow the electronic device 400 to communicate wirelessly or wired with other devices to exchange data. Although FIG. 7 illustrates electronic device 400 provided with various devices, it is to be understood that it is not required of implementation or availability of all the illustrated devices. More or fewer devices may alternatively be implemented or provided.

According to the embodiments of the present disclosure, the processes described above with reference to the flowcharts may be implemented as computer software programs. For example, embodiments of the present disclosure include a computer program product including a computer program carried on a non-transitory computer-readable medium, and the computer program contains program codes for performing the method illustrated in the flowcharts. In these embodiments, the computer program may be downloaded and installed from the network via the communication device 409, or installed from the storage device 408, or installed from the ROM 402. When the computer program is executed by the processing device 401, the above-mentioned functions defined in the method of the embodiments of the present disclosure are performed.

The electronic device provided by the embodiment of the present disclosure belongs to the same concept as the audio detection method provided by the above embodiments, technical details that are not elaborately described in the present embodiment can be referred to the above embodiments, and the present embodiment has the same effect as the above embodiment.

An embodiment of the present disclosure provides a computer storage medium comprising a computer program stored thereon, the computer program, when executed by a processor, implements the audio detection method provided by the above embodiments.

The above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any computer-readable medium other than the computer-readable storage medium. The computer-readable signal medium may send, propagate or transmit a program used by or in combination with an instruction execution system, apparatus, or device. The program code contained on the computer-readable medium may be transmitted by using any suitable medium, including but not limited to an electric wire, a fiber-optic cable, radio frequency (RF) and the like, or any appropriate combination of them.

In some embodiments, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs. When the one or more programs are executed by the electronic device, the electronic device is configured to: acquiring an audio segment in the detected audio, recognizing a music event in the audio segment; Determining metadata information matched with the music event, and determining statistical data in the detected audio based on the metadata information.

Computer program codes for performing the operations of the present disclosure may be written in one or more programming languages or a combination thereof, including but not limited to object-oriented programming languages such as Java, Smalltalk, C++, and conventional procedural programming languages such as “C” or similar programming languages. The program codes may be executed entirely on the user's computer, partly on the user's computer, as a stand-alone software package, partly on the user's computer and partly on a remote computer, or entirely on a remote computer or server. In situations involving remote computers, the remote computer can be connected to the user's computer through any kind of network, including a local area network (LAN) or a wide area network (WAN), or it can be connected to an external computer (such as an Internet service provider through Internet connection).

The flowcharts and block diagrams in the figures illustrate the architecture, functionality, and operations of possible implementations of systems, methods, and computer program products according to various embodiments of the present disclosure. In this regard, each block in the flowchart or block diagrams may represent a module, a program frame, or a portion of code which contains one or more executable instructions for implementing specified logic functions. It is also to be noted that, in some alternative implementations, the functions labeled in the block may be performed in a sequence different from those labeled in the figures. For example, two blocks shown one after another may actually be executed substantially in parallel, or they may sometimes be executed in a reverse order, depending on the functionality involved. It will also be noted that each block of the block diagram and/or flowchart, and combinations of blocks in the block diagram and/or flowchart illustration, can be implemented by special purpose hardware-based systems that perform the specified functions or operations, or can be implemented by using a combination of specialized hardware and computer instructions.

The units involved in the embodiments of the present disclosure can be implemented in software or hardware. Among them, the name of the unit/module does not constitute a limitation on the unit itself under certain circumstances.

The functions described above in the present disclosure may be performed, at least in part, by one or more hardware logic components. For example, and without limitation, exemplary types of hardware logic components that may be used include: Field Programmable Gate Arrays (FPGAs), Application Specific Integrated Circuits (ASICs), Application Specific Standard Products (ASSPs), Systems on Chips (SOCs), Complex Programmable Logical device (CPLD) and so on.

In the context of this disclosure, a machine-readable medium may be a tangible medium that may contain or store a program for use by or in connection with an instruction execution system, apparatus, or device. The machine-readable medium may be a machine-readable signal medium or a machine-readable storage medium. Machine-readable medium may include, but not limited to, electronic, magnetic, optical, electromagnetic, infrared, or semiconductor systems, apparatuses or devices, or any suitable combination of the foregoing. More specific examples of machine-readable storage medium may include one or more wire-based electrical connections, laptop disks, hard drives, random access memory (RAM), read only memory (ROM), erasable programmable read only memory (EPROM or flash memory), optical fiber, portable compact disk read-only memory (CD-ROM), optical storage device, magnetic storage device, or any suitable combination of the above.

According to one or more embodiments of the present disclosure, there is provided an audio detection method in [Example One], the method includes:
acquiring an audio segment in a detected audio, and recognizing a music event in the audio segment; and
determining metadata information matched with the music event, and determining statistical data in the detected audio based on the metadata information.

According to one or more embodiments of the present disclosure, there is provided an audio detection method in [Example Two], further including:
the recognizing a music event in the audio segment, including:
inputting the audio segment into a pre-trained music recognition model to obtain a music event recognition result output by the music recognition model, wherein the music recognition model is trained based on audio samples and event tags corresponding to the audio samples.

According to one or more embodiments of the present disclosure, there is provided an audio detection method in [Example Three], further including:
after recognizing a music event in the audio segment, the method further includes:
determining whether a duration of the music event in the audio segment is greater than a first preset duration, and cancelling a tag for the music event in response to the duration of the music event in the audio segment being not greater than the first preset duration.

According to one or more embodiments of the present disclosure, there is provided an audio detection method in [Example Four], further including:
the determining metadata information matched with the music event includes:
for an audio segment containing a music event, extracting an audio fingerprint feature of the audio segment;
determining metadata information matched with the music event based on the audio fingerprint feature being matched in a fingerprint feature library, wherein the fingerprint feature library includes music metadata and corresponding fingerprint features.

According to one or more embodiments of the present disclosure, there is provided an audio detection method in [Example Five], further including:
the extracting an audio fingerprint feature of the audio segment includes:
intercepting the audio segment according to a start-end timestamp of the music event in the audio segment to obtain an intercepted audio segment, and extracting the audio fingerprint feature of the intercepted audio segment; alternatively,
extracting, in the audio segment, audio data of an audio track where the music event is located, and extracting the audio fingerprint feature based on the audio data of the audio track where the music event is located.

According to one or more embodiments of the present disclosure, there is provided an audio detection method in [Example Six], further including:
the determining statistical data in the detected audio based on the metadata information includes:
merging the music events corresponding to the same metadata information according to the start-end timestamp of the music events in each audio segment to obtain statistical data in the detected audio.

According to one or more embodiments of the present disclosure, there is provided an audio detection method in [Example Seven], further including:
the merging the music events corresponding to the same metadata information according to the start-end timestamp of the music events in each audio segment to obtain statistical data in the detected audio, includes:
for adjacent music events, if the adjacent music events correspond to the same metadata information and an interval duration between the adjacent music events is less than a second preset duration, merging the adjacent music events;
if the adjacent music events correspond to different metadata information, or, if the adjacent music events correspond to the same metadata information and the interval duration between the adjacent music events is greater than or equal to the second preset duration, the adjacent music events are not merged.

According to one or more embodiments of the disclosure, there is provided an audio detection method in [Example Eight], further including:
the detected audio is an audio in a live video;
the method further includes:
determining viewing data for a live interval to which each piece of metadata information in the statistical data corresponds.

According to one or more embodiments of the present disclosure, there is provided an audio detection apparatus in [Example Nine], the apparatus includes:
a music event recognition module, configured to acquire an audio segment in a detected audio and recognize a music event in the audio segment; and
a statistical data determination module, configured to determine metadata information matched with the music event, and determine statistical data in the detected audio based on the metadata information.

Furthermore, although various operations are depicted in a specific order, this should not be understood as requiring that these operations be performed in the specific order as shown or performed in a sequential order. Under certain circumstances, multitasking and parallel processing may be advantageous. Likewise, although several specific implementation details are included in the above discussion, these should not be construed as limiting the scope of the present disclosure. Certain features that are described in the context of separate embodiments can also be implemented in combination in a single embodiment. Vice versa, various features that are described in the context of a single embodiment can also be implemented in multiple embodiments separately or in any suitable sub-combination.

1. An audio detection method, comprising:
acquiring an audio segment in a detected audio, and recognizing a music event in the audio segment; and
determining metadata information matched with the music event, and determining statistical data in the detected audio based on the metadata information.

2. The method according to claim 1, wherein the recognizing a music event in the audio segment comprises:
inputting the audio segment into a pre-trained music recognition model to obtain a music event recognition result output by the music recognition model, wherein the music recognition model is trained based on an audio sample and an event tag corresponding to the audio sample.

3. The method according to claim 1, after the recognizing a music event in the audio segment, further comprising:
determining whether a duration of the music event in the audio segment is greater than a first preset duration, and cancelling a tag for the music event in response to the duration of the music event in the audio segment being not greater than the first preset duration.

4. The method according to claim 1, wherein the determining metadata information matched with the music event comprises:
for the audio segment containing the music event, extracting an audio fingerprint feature of the audio segment; and
determining metadata information matched with the music event based on the audio fingerprint feature being matched in a fingerprint feature library, wherein the fingerprint feature library comprises music metadata and corresponding fingerprint features.

5. The method according to claim 4, wherein the extracting an audio fingerprint feature of the audio segment comprises:
intercepting the audio segment according to a start-end timestamp of the music event in the audio segment to obtain an intercepted audio segment, and extracting an audio fingerprint feature of the intercepted audio segment; or,
extracting, in the audio segment, audio data of an audio track where the music event is located, and extracting the audio fingerprint feature based on the audio data of the audio track where the music event is located.

6. The method according to claim 1, wherein the determining statistical data in the detected audio based on the metadata information comprises:
merging music events corresponding to the same metadata information according to a start-end timestamp of the music event in each audio segment to obtain the statistical data in the detected audio.

7. The method according to claim 6, wherein the merging music events corresponding to the same metadata information according to a start-end timestamp of the music event in each audio segment to obtain the statistical data in the detected audio, comprises:
for adjacent music events,
in response to the adjacent music events corresponding to the same metadata information and an interval duration between the adjacent music events being less than a second preset duration, merging the adjacent music events;
in response to the adjacent music events corresponding to different metadata information, or, in response to the adjacent music events corresponding to the same metadata information and the interval duration between the adjacent music events being greater than or equal to the second preset duration, the adjacent music events are not merged.

8. The method according to claim 1, wherein the detected audio is an audio in a live video;
the method further comprises:
determining viewing data for a live interval to which each piece of metadata information in the statistical data corresponds.

9. (canceled)

10. An electronic device, comprising:
at least one processor; and
a storage device configured to store at least one program, wherein
the at least one program, when executed by the at least one processor, is configured to cause the at least one processor to implement an audio detection method, comprising:
acquiring an audio segment in a detected audio, and recognizing a music event in the audio segment; and
determining metadata information matched with the music event, and determining statistical data in the detected audio based on the metadata information.

11. (canceled)

12. A computer program product, comprising a computer program carried on a non-transitory computer readable medium, wherein
the computer program comprises program codes configured to implement an audio detection method, comprising:
acquiring an audio segment in a detected audio, and recognizing a music event in the audio segment; and
determining metadata information matched with the music event, and determining statistical data in the detected audio based on the metadata information.

13. The electronic device according to claim 10, wherein in the audio detection method,
the recognizing a music event in the audio segment comprises:
inputting the audio segment into a pre-trained music recognition model to obtain a music event recognition result output by the music recognition model, wherein the music recognition model is trained based on an audio sample and an event tag corresponding to the audio sample.

14. The electronic device according to claim 10, wherein in the audio detection method,
after the recognizing a music event in the audio segment, further comprising:
determining whether a duration of the music event in the audio segment is greater than a first preset duration, and cancelling a tag for the music event in response to the duration of the music event in the audio segment being not greater than the first preset duration.

15. The electronic device according to claim 10, wherein in the audio detection method,
the determining metadata information matched with the music event comprises:
for the audio segment containing the music event, extracting an audio fingerprint feature of the audio segment; and
determining metadata information matched with the music event based on the audio fingerprint feature being matched in a fingerprint feature library, wherein the fingerprint feature library comprises music metadata and corresponding fingerprint features.

16. The electronic device according to claim 15, wherein in the audio detection method,
the extracting an audio fingerprint feature of the audio segment comprises:
intercepting the audio segment according to a start-end timestamp of the music event in the audio segment to obtain an intercepted audio segment, and extracting an audio fingerprint feature of the intercepted audio segment; or,
extracting, in the audio segment, audio data of an audio track where the music event is located, and extracting the audio fingerprint feature based on the audio data of the audio track where the music event is located.

17. The electronic device according to claim 10, wherein in the audio detection method,
the determining statistical data in the detected audio based on the metadata information comprises:
merging music events corresponding to the same metadata information according to a start-end timestamp of the music event in each audio segment to obtain the statistical data in the detected audio.

18. The electronic device according to claim 17, wherein in the audio detection method,
the merging music events corresponding to the same metadata information according to a start-end timestamp of the music event in each audio segment to obtain the statistical data in the detected audio, comprises:
for adjacent music events,
in response to the adjacent music events corresponding to the same metadata information and an interval duration between the adjacent music events being less than a second preset duration, merging the adjacent music events;
in response to the adjacent music events corresponding to different metadata information, or, in response to the adjacent music events corresponding to the same metadata information and the interval duration between the adjacent music events being greater than or equal to the second preset duration, the adjacent music events are not merged.

19. The electronic device according to claim 10, wherein the detected audio is an audio in a live video;
the audio detection method further comprises:
determining viewing data for a live interval to which each piece of metadata information in the statistical data corresponds.
